(19) United States
(12) Patent Application Publication
(10) Pub. No.: US 2008/0283426 A1
(43) Pub. Date: Nov. 20, 2008

(54) Medical treatment package for medical care products

(76) Inventors: Jonathan S. Primer, Highland Park, IL (US); Susan E. Macinnes, Cary, IL (US)

Correspondence Address: NIXON PEABODY, LLP, 161 N. CLARK ST., 48TH FLOOR, CHICAGO, IL, 60601-3213, US

(21) Appl. No.: 12/004,796

(22) Filed: Dec. 21, 2007

Related U.S. Application Data
(63) Continuation-in-part of application No. 11/804,438, filed on May 17, 2007.

(51) Int. Cl. B65D 73/00; B65D 71/06; A61J 1/00

(52) U.S. Cl. 206/232; 206/570

(57) ABSTRACT

A medical treatment package includes at least one medical care product and an individual container in which the at least one medical care product is stored prior to usage. The medical treatment package further includes a booklet-type label affixed to an exterior surface of at least one individual container, the booklet-type label including on its interior surface medical treatment information.

### CROSS-REFERENCE TO RELATED APPLICATIONS

This application is a continuation-in-part of U.S. patent application Ser. No. 11/804,438, filed May 17, 2007, which is hereby incorporated by reference in its entirety.

### FIELD OF THE INVENTION

The present invention relates generally to medical care products. More particularly, the present invention relates to a medical treatment package for medical care products that includes various types of information relating to the medical care products.

### BACKGROUND OF THE INVENTION

A wound is a break in the skin that is caused by a cut or a scrape. To minimize the possibility of scarring and/or infection, wound care treatment should be performed based on several factors, including a patient's age, wound size, wound location, wound severity, etc. The wound treatment is based on the type of wound (i.e., “light” or “severe”) and can vary based on one or more of the factors listed above. For example, a light wound generally requires few dressing changes and, as such, it may only require a plain cloth bandage, e.g., BAND AID® adhesive bandages, for keeping the wound clean during the healing process. In general, light wounds are the types of wounds that do not require special treatment care, e.g., lights scrapes or cuts.

In contrast to light wounds, severe wounds require special treatment care. Treatment of severe wounds is generally performed in accordance with specific treatment directions that are generally customized to each individual patient based on one or more of the factors listed above. Because of the complexity of the severe wounds and the varying individual patient factors, treatment of severe wounds is not simple or straightforward. Although treatment of a light wound may be as simple as applying a single plain cloth bandage to the wound, treatment of a severe wound requires appropriate treatment that seeks to address problems that cause the severe wound. Thus, the treatment of a severe wound requires proper instructions, which may change during different stages of treatment, and proper application of the instructions, which must be followed precisely. Similarly, treatment of other medical conditions require proper instruments to apply and/or use the medical care products. A patient might benefit from having proper instruments on how to apply and/or use, for example, but not limited to, woven gauze sponges; sterile pads; abdominal/combine pads; impregnated gauze, including, but not limited to, petroleum gauze, oil emulsion gauze, and xeroform gauze; roll-type bandages, including, but not limited to, gauze bandage rolls, elastic bandages, and cohesive wraps; adhesive bandages; sterile procedure trays (“SPTs”); skincare products including, but not limited to, lotions, cleansers, and protectants; hot and cold therapy products; medical tapes including, but not limited to, paper, cloth, transparent, foam, and athletic; medical briefs (e.g., medical garments); and chronic wound dressings.

Specifically, treatment of severe wounds, including chronic wounds, is generally directed to healing through secondary intention, which refers to the wound closing by contraction and reepithelialization. For example, if there are post-operative complications such as infections, wound dehiscence, excessive scar, or excessive drainage, the wounds would heal by secondary intention. In other words, the wound is allowed to heal by forming granulation tissue from a bottom of the wound outward. In contrast, primary wound healing (or healing by first intention) occurs when the wound is not contaminated, dead spaces are closed, tissue is handled gently, hemostasis is achieved, and the tissues are approximated accurately.

One type of severe wound is a chronic wound, such as a pressure sore, a diabetic foot ulcer, and an arterial ulcer. Chronic wounds have been referred to as wounds that do not heal in an orderly set of stages and in a predictable amount of time. In fact, chronic wounds may take years to heal or may never heal. When treating chronic wounds, the person performing the treatment generally addresses the cause of the chronic wounds, including ischemia, bacterial load, and imbalance of proteases. Some methods used to ameliorate the cause of chronic wounds include antibiotic and antibacterial use, debridement, irrigation, vacuum-assisted closure, warming, oxygenation, moist wound healing, removing mechanical stress, and adding cells or other materials to secrete or enhance levels of healing factors.

Regardless of whether the person performing the treatment is a medical care professional (e.g., doctor, nurse, etc.) or an end user (e.g., wounded person, family, etc.), that person must follow precise treatment directions and use any required medical care products for the patient's medical condition properly. For example, the person performing the treatment on a sever wound must know how to use and apply wound care products such as wound dressings (e.g., chronic wound dressings), gauze dressings, and bandages. The problem is that often the treating person lacks any knowledge of how to open the wound care product, how to use it properly, how to remove it properly, etc.

For example, when using a wound dressing impregnated with a variety of substances, such as hydrogels, saline, antimicrobial agents, and other substances, the treating person often does not know whether the wound dressing is appropriate for use for a specific type of severe wound in a specific patient. Accordingly, one problem associated with some impregnated wound dressings is that they fail to provide usage information, such as usage directions in a suitable manner for use by the treating person when treating the severe wound.

Many medical care products are individually packaged as single-use medical care items, which, in turn, are packaged in containers housing a plurality of the single-use medical care items. Although printed information, such as usage information or directions, may sometimes be provided on the container, the single-use medical care items lack similar printed information or any printed information. Often, the container is discarded and the treating person is left with single-use medical care items that, in many instances, lack any kind of printed information, such as usage information or directions. In fact, especially in a health treatment facility (e.g., a hospital), the container is likely to be inadvertently misplaced or discarded based on constant change of personnel, patients, and care. If the container is unavailable, the printed information generally available on the container is also unavailable to the treating person. Thus, the treating person may be forced to apply a medical care product without the benefit of the printed information, such as usage information or directions. Likely, the treating person may use blank (information-less) items, and, therefore, increase the potential for medical care errors and waste caused by an improper initial application and the need for a re-application of the medical care product. Alternatively, if the treating person chooses to err on the safe side, he or she will likely discard any unused medical care products and, accordingly, increase financial waste associated with the health care costs.

According to some statistics, for example, wound care financial waste translates into high medical costs—financial waste accounts for 25-40% of all hospital costs (e.g., a total medical error cost of $9.3 billion, with an increased cost to hospitals of $4,700 per admission). Wound care errors also translate into fatal results—approximately 98,000 people die in any given year from medical errors that occur in hospitals (deaths due to medical error exceed suicide, which is the eighth leading cause of death). Furthermore, the statistics show that 1 in every 20 patients contract an infection in the hospital and that 40 to 50 patient injuries per 100 hospital admissions are injured by hospital care. Thus, improved treatment care of medical conditions can reduce hospital infections and financial waste.

Another problem associated with some medical care products is that they fail to provide efficient means for correlating relevant medical care information to a respective patient. For example, after dressing a wound, the treating person must generally rely on memory or on clear communications to remember when to change a wound dressing. In health care settings, overworked and/or inexperienced professionals and confusion created by frequent medical procedures on the patient are some exemplary causes of human error when treating a medical condition. Thus, the potential for improper wound treatment is high based on the high potential for human error. For example, miscommunication between professionals regarding changing a wound dressing can result in a wound dressing being changed too soon or too late. In turn, the improper changing of wound dressings can delay the healing process (e.g., if the wound dressing is changed too soon) and/or can increase the potential for infection (e.g., if the wound dressing is changed too late). In another example, a medical care professional may forget any special conditions associated with a particular patient. Applying the wrong medical care product can have serious adverse, and potentially deadly, effects on the patient.

Therefore, a need exists for a plurality of medical care products that include printed information for treatment of medical conditions, such as usage information or directions on individual single-use medical care items, and/or that provide efficient means for correlating relevant medical care information to a respective patient.

### SUMMARY OF THE INVENTION

According to one implementation, a medical treatment package includes at least one medical care product and an individual container in which the at least one medical care product is stored prior to usage. The medical treatment package further includes a booklet-type label affixed to an exterior surface of at least one individual container, the booklet-type label including on its interior surface medical treatment information.

According to another implementation, a method for providing a medical treatment package includes inserting a medical care product into an individual container and attaching a booklet-type label to an exterior surface of the individual container. The method further includes providing a set of usage directions for treating a medical condition. The set of usage directions is located on an interior surface of the booklet-type label.

According to a further implementation, a medical treatment package for treatment of a medical condition includes a package housing, a plurality of individually-contained medical care products stored in the package housing prior to usage, and a booklet-type label. The booklet-type label is affixed to an exterior surface of each of the individually-contained medical care products and includes on its interior surface medical treatment information for treatment of the medical condition.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 illustrates a perspective view of a wound dressing box having a plurality of individual wound dressing pouches.

FIG. 2 illustrates a perspective view of one of the wound dressing pouches shown in FIG. 1.

FIG. 3 illustrates the wound dressing pouch shown in FIG. 2 having its booklet label in an open position.

FIG. 4 illustrates a removable label of the booklet label shown in FIG. 3 located on a wound dressing.

FIG. 5 illustrates the wound dressing pouch shown in FIG. 2 having a secondary label.

FIG. 6 illustrates a perspective view of an abdominal/combine pad box having a plurality of individual abdominal/combine pad packages.

FIG. 7 illustrates one of the abdominal/combine pad packages shown in FIG. 6, in an expanded form, having its booklet label in an open position.

FIG. 8 illustrates a perspective view of a gauze bandage rolls box having a plurality of individual gauze bandage rolls packages, one of the gauze bandage rolls dispensed in the front of the box.

FIG. 9 illustrates an elastic bandage having its booklet label in an open position.

FIG. 10 illustrates a perspective view of a sterile procedure tray (“SPT”) box having a plurality of individual STP packages.

FIG. 11 illustrates one of the STP packages shown in FIG. 10 having its booklet label in an open position.

FIG. 12 illustrates a perspective view of a skin care product box having a plurality of individual skin care products in individual bottle-type packages.

FIG. 13A illustrates one type of skin care product, in an individual jar-type package, having its booklet label in an open position.

FIG. 13B illustrates one type of skin care product, in an individual tube-type package, having its booklet label in an open position.

FIG. 13C illustrates one type of skin care product shown in FIG. 12, in an individual bottle-type package, having its booklet label in an open position.

FIG. 14 illustrates a perspective view of a tape box having a plurality of individual rolls of tape packages.

FIG. 15A illustrates one of the rolls of tape shown in FIG. 14, in an individual package, having its booklet label in a closed position.

FIG. 15B illustrates one roll of tape, without an individual package, having its booklet label in an open position.

FIG. 16 illustrates a perspective view of a brief box containing a plurality of individual brief packages.

FIG. 17 illustrates a perspective view of a brief, in an individual package, having its booklet label in a closed position.

FIG. 18A illustrates a perspective view of a brief, without an individual package, having its booklet label in a closed position.

FIG. 18B illustrates the brief shown in FIG. 18A, having its booklet label in an open position.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

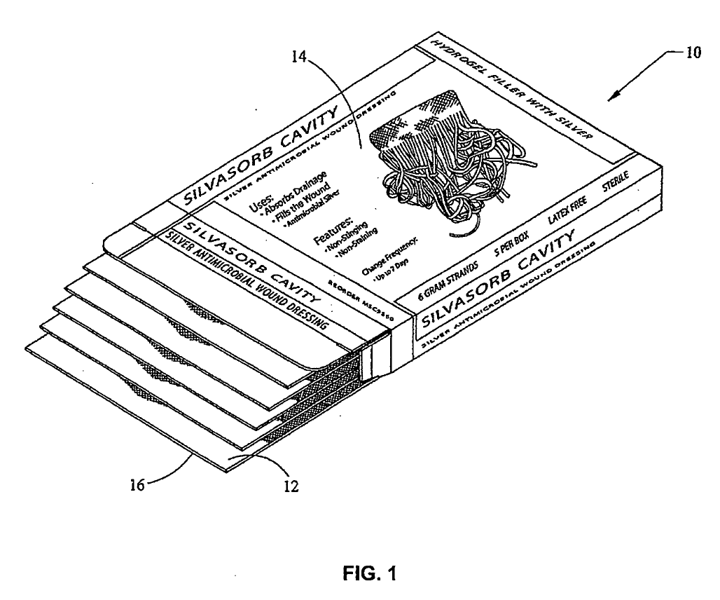

Referring to FIG. 1, a plurality of wound care products are packaged together in a single package for treatment of severe wounds. Each wound care product is a single-use wound care item that is inserted into a corresponding individual package. For example, one type of wound care products for treatment of severe wounds is a wound dressing. According to one implementation, a package for one or more wound dressings includes a container in the shape of a box 10 and five wound dressings individually packaged in respective pouches 12. In alternative implementations, the container can be any type, size, or shape (e.g., a circular box, a rectangular bag, etc.), can be any material, and can include any number of wound dressing packages. In other alternative implementations, the wound dressing packages can be any type, size, or shape, and can be any material. For example, instead of or in addition to pouches, the individual packages can be individual boxes, individual bags, individual envelopes, etc.

The box 10 has printed information on one or more of its surfaces. For example, the box 10 includes directions, usage information, and ingredient information on its front surface 14. In alternative implementations, the printed information can be on any surface of the box 10 and can include any other information, including product classification information. The classification information can be used to easily identify the type of wound care product and its applications.

In the implementation illustrated in FIG. 1, each pouch 12 is made from a couple of sheets that are affixed to each other along each edge to preserve, prior to usage, a single wound dressing. The sheets can be made of any material, including polypropylene, plastic, foil, paper, etc. To remove the wound dressing, a wound care professional generally peels apart the sheet along a removably affixed edge 16.

The wound dressing, or similar wound care products, is used to maintain an optimal level of moisture, can be impregnated with various wound care products, can have ingredients that are absorptive, etc. For example, the wound dressings can be used to treat severe wounds, including chronic wounds such as pressure sores, diabetic foot ulcers, arterial ulcers, etc. The wound dressing can be, for example, a silver antimicrobial wound dressing, a silver antimicrobial barrier wound dressing, a non-adhesive foam wound dressing, an adhesive foam wound dressing, a chronic wound dressing, and/or combinations thereof, etc. In more general examples, the wound care products can include any hydrogel, hydrogel with silver, hydrogel filler with silver, hydrogel sheet, hydrogel sheet with silver, hydrogel perforated sheet with silver, hydrogel barrier with silver, tape, transparent film, wound filler, foam, foam with silver, combinations thereof, etc. In more specific examples, the wound care products can be products known as DERMA-GEL™, TENDERWET™, SILVASORB™, AQUAFLO™, AQUASORB™, CARRADRESS CLEAR™, CLEARSITE™, or CURAGEL™ (all products being available from Medline Industries, Inc. located in Mundelein, Ill.). In alternative implementations, other types of wound care products (including other types of wound dressings) can be used for treating severe wounds or chronic wounds.

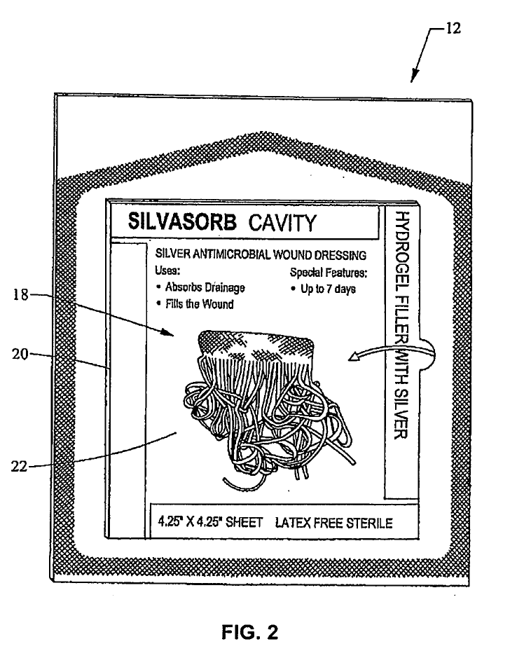

Referring to FIG. 2, a main label 18 is attached to an exterior surface of the pouch 12. The main label 18 is generally a booklet-type label that includes two pages (or sheets), which are attached to each other along a single edge 20. On its cover 22, which is the exterior surface of a top one of the two pages, the main label 18 includes printed information (such as directions) related to the enclosed wound dressing. For example, if the wound dressing is a hydrogel filler with silver, the cover generally describes applicable uses (e.g., absorbs drainage, fills the wound) and wound dressing size (e.g., 4.25″×4.25″ sheet). For this type of wound dressing, the cover 22 of the main label 18 can be opened, as indicated by the arrow, to reveal other information printed inside the main label 18.

The main label 18 provides useful information related to wound care products for treating severe wounds, such as wound dressings, in a clear and understandable form. The printed information is intended to bring clarity and understanding regarding the wound care product contained within the individual package to an end user, including a nurse, patient, and patient's family. As such, the printed information reduces (and hopefully, eliminates) confusion about the many types of products that a patient may require. For example, the printed information can help to educate an overworked nurse that may have limited knowledge on wound care and that is juggling many duties. Thus, the main label 18 makes it difficult for the end user, such as a healthcare worker, to make improper or incorrect use of the individually packaged wound care product. The main label 18 reduces costs associated with medical errors.

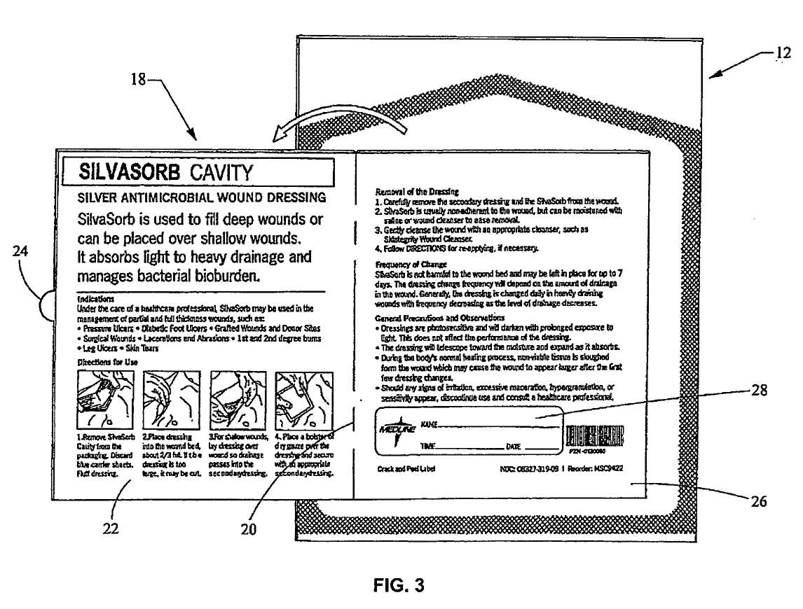

Referring to FIG. 3, the main label 18 has been opened and it shows additional information regarding wound dressing instructions, directions, usage, ingredients, and/or warnings. According to this implementation, the main label 18 can be opened by lifting a tab 24. The information is optionally printed on both interior sides of the main label 18. Specifically, the information can be printed on both the interior side of the top (or cover) page 22 and on the interior side of a bottom page 26. The printed information can be duplicative of information printed on the box 10 and, optionally, can include additional information.

According to an exemplary implementation, the information on the main label 18 can include photographic instructions. The photographic instructions can be used in addition to or instead of the printed information as described herein in reference to the wound dressing packages. Through the assistance of photography, such as explicit diagrams, drawings, and/or photographs, in conjunction with written textual instructions, even non-qualified users can safely use the enclosed wound care products. For example, any member of the patient's family, including English and non-English speaking members, should be able to follow the easy to use instructions by following the displayed diagrams. It is contemplated that a main label, the same as or similar to the main label 18 of FIG. 2, may be attached to other medical care products described herein.

A removable label 28 is attached to the interior surface of the bottom page 26 of the main label 18. The removable label 28 can be used on any type of wound dressing package described herein. The removable label 28 can also be used on any type of medical care product described herein. The removable label 28 can be attached using any means, such as adhesive means or heat seal means. The removable label 28 includes a markable area for printing information related to the wound being treated or the area being addressed by the medical care product. The printed information can be handwritten by the wound or medical care treating person or it can be imprinted by a generally available printer machine. According to the illustrated implementation, the removable label 28 includes both preprinted information and blank areas for on-the-spot marking of patient-specific information. For example, the preprinted information can include a patient's “NAME,” a “TIME” of dressing change, and/or a “DATE” of dressing change. Next to each piece of preprinted information, the treating person can easily mark any relevant wound or medical information.

The removable label 28 can be a crack-and-peel label, a pre-perforated detachable label, etc. The removable label 28 can be located in any desirable location on main label 18. For example, in an alternative implementation, the removable label 28 can be located along the edge of the cover of the main label 18 using a pre-perforated label. Optionally, the cover can include two adjacent pre-perforated labels that can be easily detached by the treating person.

Referring to FIG. 4, the removable label 28 is illustrated located on a wound dressing 30 on a patient wound 32. For example, a wound care professional first removes the wound dressing 30 from its respective pouch 12 and, then, places it on the wound 32. Subsequently, the wound care professional can place the removable label 28 directly on the wound dressing 30 to identify, for example, the specific time and date when the dressing change occurred. Other relevant information, such as special instructions, patient's age, patient's sex, etc., can be optionally marked on the removable label 28. The removable label 28 is useful in reducing the potential for human error when treating a wound, e.g., changing the wound dressing too soon or too late.

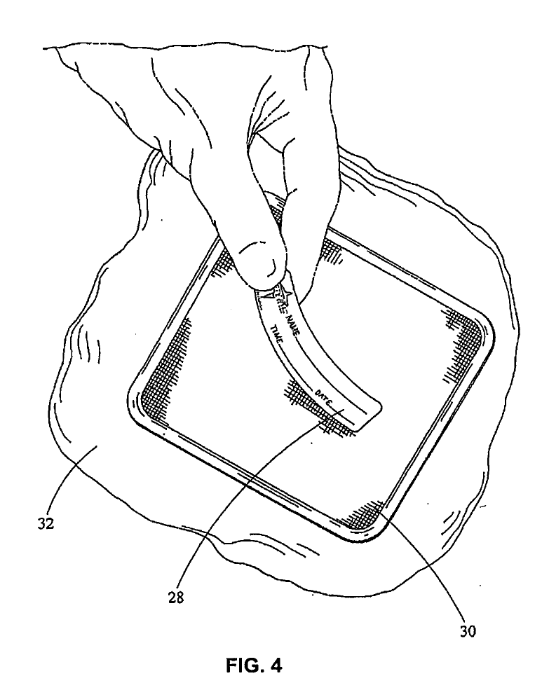

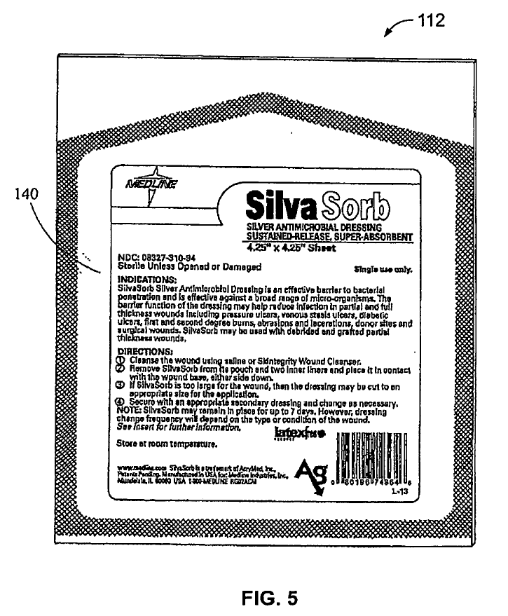

Referring to FIG. 5, a pouch 112 includes a secondary label 140 in accordance with an alternative implementation. In this implementation, the secondary label 140 is a sheet with directions and is initially obscured by a booklet label (not shown) similar to main label 18 described above in reference to FIGS. 1-4. While the booklet label can provide detailed information for the treating person, the booklet-type label may be deemed as being unnecessary for a number of reasons, e.g., to further reduce storage space. Thus, the booklet label can be removably attached to the pouch 112 for providing the treating person with great flexibility as to whether the booklet label should be preserved or discarded. To eliminate the potential for wound dressing misuse when the booklet label is discarded, the secondary label 140 is permanently affixed between the pouch 112 and the discarded booklet label. Due to minimal space availability, the secondary label 140 generally includes a shorter version of the information printed on the discarded booklet label. Another advantage of providing the secondary label 140 is to provide relevant information for the health care professional when the booklet label is inadvertently discarded. The secondary label 140 can be used with any wound dressing package described herein. It is contemplated that a secondary label, the same as or similar to the secondary label 140 of FIG. 3, may be attached to other medical care products described herein.

In alternative implementations, the wound care product packages described herein can be packages for a variety of additional medical care products. It is contemplated that the packages described herein may include any package housing that contains one or more medical care products within an individual container. For example, wound care product packages illustrated herein also encompass the following medical care products: woven gauze sponges; sterile pads; abdominal/combine pads; impregnated gauze, including, but not limited to, petroleum gauze, oil emulsion gauze, and xeroform gauze; roll-type bandages, including, but not limited to, gauze bandage rolls, elastic bandages, and cohesive wraps; adhesive bandages; sterile procedure trays (“SPTs”); skincare products including, but not limited to, lotions, cleansers, and protectants; hot and cold therapy products; medical tapes including, but not limited to, paper, cloth, transparent, foam, and athletic; medical briefs (e.g., medical garments); and chronic wound dressings. All of these medical care products can be supplied in a package housing that contains one or more individual pouches or medical containers or items, wherein each of these individual pouches, containers, or items contains an individual medical care product. It is further contemplated that a single package housing may contain a variety of different medical care products, wherein each medical care product includes a main label containing information relating to the medical care product contained therein.

In certain embodiments, a medical treatment package for one or more medical care products comprises a package housing in the shape of box 10 of FIG. 1 and an individual pouch 12. It is contemplated that the pouch 12 may contain a variety of medical care products (the wound dressing shown in FIG. 4 is only one example of a type of medical care product). In alternative implementations, the package housing (e.g., box 10) can be any type, size, or shape, including, but not limited to, a circular box, a rectangular box, a plastic bag, a paper bag, and a shrink-wrap; can be any material; and can include any number of medical care products. In other alternative implementations, the pouch 12 can be any type, size, or shape, and can be any material. For example, pouch 12 may be an individual box, individual container, individual package, individual bag (paper or plastic, etc.), individual envelope, or an individual shrink-wrap, etc.

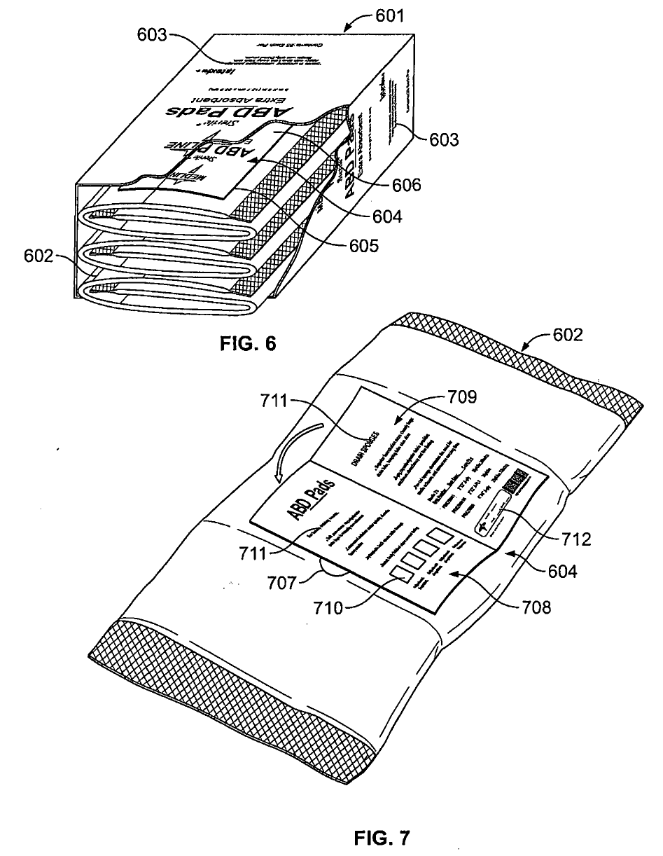

Referring to FIG. 6, a plurality of abdominal/combine pads are packaged together in a single package. Abdominal/combine pads may be used to treat wounds with heavy drainage, while keeping the wound dry. According to one implementation, a package for the one or more abdominal/combine pads includes a package housing in the shape of a box 601 and three abdominal/combine pads packaged individually in a folded pouch 602. In alternative implementations, the package housing can be any type, size, or shape, including, but not limited to, a circular box, a rectangular box, a plastic bag, a paper bag, and a shrink-wrap; can be any material; and can include any number of abdominal/combine pads. In other alternative implementations, the abdominal/combine pad folded pouch 602 can be any type, size, or shape, and can be any material. For example, the folded pouch 602 may be an individual box, individual container, individual bag (paper or plastic, etc.), individual envelope, or an individual shrink-wrap. In yet another alternative implementation, the abdominal/combine pad is in an unfolded pouch, wherein the box 601 is of sufficient size to accommodate an unfolded pouch containing an abdominal/combine pad of any size, shape, or type.

The box 601 has printed information on one or more of its surfaces 603. A main label 604 is attached to an exterior surface of the folded pouch 602. The main label 604 can be attached to any area of the folded pouch, not just in the center portion as shown in FIG. 7. The main label 604 is generally a booklet-type label that includes two pages (or sheets), which are attached to each other along a single edge 605. On the main label's cover 606, which is the exterior surface of the top one of the two pages, the main label 604 includes printed information (such as directions) related to the enclosed abdominal/combine pad. It is contemplated that the main label may contain the same or similar information as the main label 18 of FIGS. 2, 3

Referring to FIG. 7, the folded pouch 602 is shown in an unfolded orientation. The main label 604 is shown in an opened position to reveal medical care product information 711 printed inside the top (or cover) page 708 and inside the bottom page 709 of the main label 604. The medical care product information 711 can include abdominal/combine pad instructions, directions, usage, ingredients, and/or warnings. According to this exemplary implementation, the main label 604 can be opened by lifting a tab 707. The medical care product information 711 can be duplicative of information printed on the box 601 and, optionally, can include additional information. According to another exemplary implementation, the information on the main label 604 can include photographic instructions 710, the same as or similar to the photographic instructions on the main label 18 described herein. The photographic instructions 710 can be used in addition to or instead of the printed information as described herein in reference to the abdominal/combine pad packages.

A removable label 712 is optionally attached to the interior surface of the bottom page 709 of the main label 604 and can be used with the abdominal/combine pads in the same or similar manner as described in relation to the removable label 28 in FIG. 3. It is contemplated that the folded pouch 602 may include a secondary label, the same as or similar to the secondary label 140 of FIG. 5.

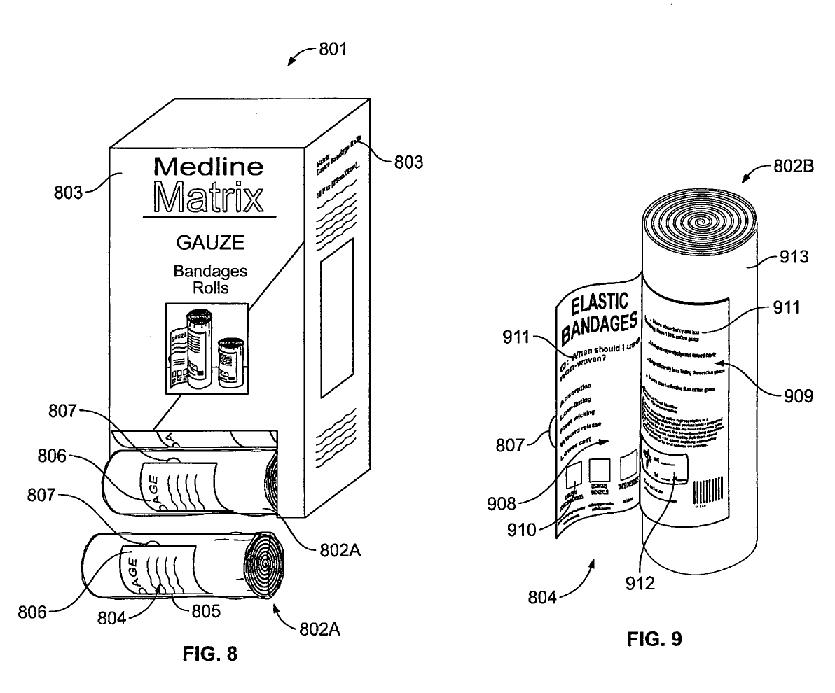

Referring to FIG. 8, a plurality of roll-type bandages are packaged together in a single package. A roll-type bandage is typically a sheet of material rolled up in a cylindrical shape. Roll-type bandages include, but are not limited to: gauze bandage rolls, elastic bandages, and cohesive wraps. The roll-type bandage can be any material, any size, and any shape. According to one implementation, a package for the one or more roll-type bandages includes a package housing in the shape of a box 801 and a plurality of roll-type bandages (shown as gauze bandage rolls) packaged individually in a shrink-wrap 802A. In alternative implementations, the container can be any type, size, or shape, including, but not limited to, a circular box, a rectangular box, a bag, a shrink-wrap, an envelope, or a pouch; can be any material; and can include any number of roll-type bandages. In other alternative implementations, the roll-type bandage shrink-wrap 802A can be any type, size, or shape, and can be any material. For example, the shrink-wrap may be an individual box, an individual bag (paper or plastic, etc.), an individual envelope, an individual container, or an individual pouch.

The box 801 has printed information on one or more of its surfaces 803. A main label 804 is attached to an exterior surface of the shrink-wrap 802A. The main label 804 is generally a booklet-type label that includes two pages (or sheets), which are attached to each other along a single edge 805. On the main label's cover 806, which is the exterior surface of the top one of the two pages, the main label 804 includes printed information (such as directions) related to the enclosed roll-type bandage (e.g., gauze bandages rolls, elastic bandages, or cohesive wraps). It is contemplated that the main labels may contain the same or similar information as the main label 18 of FIGS. 2, 3.

Referring to FIG. 9, an alternative implementation shows a roll-type bandage 802B without shrink-wrap. It is contemplated that if the roll-type bandage does not include a shrink-wrap, the main label 804 may be attached directly to an exterior surface 913 of the roll-type bandage. In either implementation, with or without shrink-wrap, the main label 804 includes medical care product information 911 printed inside a top (or cover) page 908 and/or inside a bottom page 909 of the main label 804. Medical care product information 911 can include roll-type bandage instructions, directions, usage, ingredients, and/or warnings. According to this implementation, the main label 804 can be opened by lifting a tab 807. The medical care product information 911 can be duplicative of information printed on the box 801 and, optionally, can include additional information. According to another exemplary implementation, the information on the main label 804 can include photographic instructions 910, the same as or similar to the photographic instructions on the main label 18 described herein. The photographic instructions 910 can be used in addition to or instead of the printed information as described herein in reference to the roll-type bandage packages.

A removable label 912 is optionally attached to the interior surface of the bottom page 909 of the main label 804 and can be used with the roll-type bandages in the same or similar manner as described in relation to the removable label 28 in FIG. 3. It is contemplated that the shrink-wrap roll-type bandage 802A and/or the roll-type bandage 802B without a shrink-wrap may include a secondary label the same as or similar to the secondary label 140 of FIG. 5.

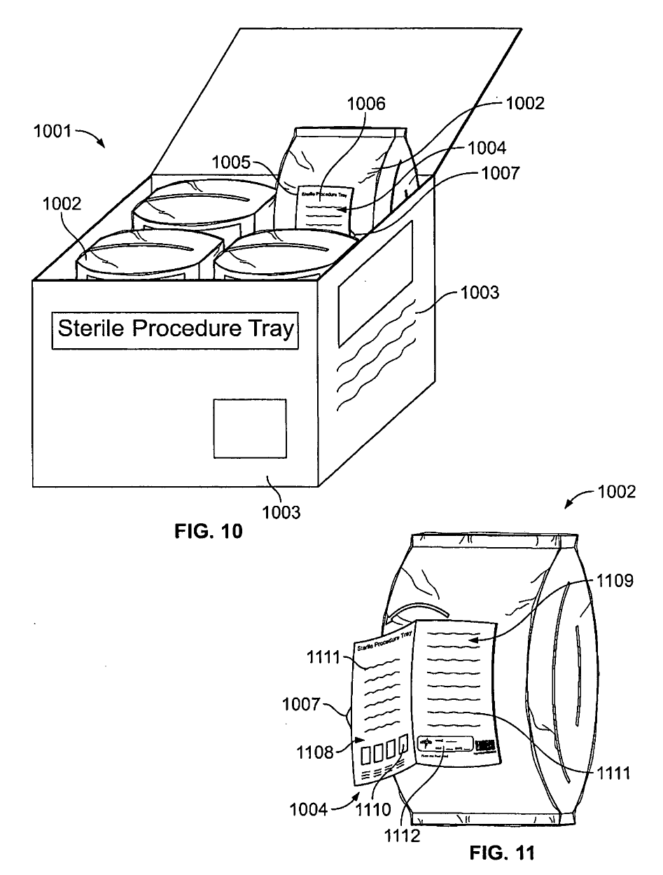

Referring to FIG. 10, a plurality of sterile procedure trays (“STPs”) are packaged together in a single package. An STP typically comprises a standardized package of a plurality of a medical instruments and medical care products used when performing a medical procedure. The standardized package of products lowers inventory costs, streamlines the ordering process, and reduces the time it takes medical personal to perform a medical procedure. The STP can include any described medical or non-medical care products or combinations of medical and/or non-medical care products, used during a medical procedure. The STP outer packaging can be any material, any size, and any shape. According to one implementation, a package for the one or more STPs includes a package housing in the shape of a box 1001 and a plurality of STPs individually packaged in a bag-type pouch 1002. In alternative implementations, the package housing can be any type, size, or shape, including, but not limited to, a circular box, a rectangular box, a plastic bag, a paper bag, or a shrink-wrap; can be any material; and can include any number of STPs. In other alternative implementations, the STP bag-type pouch 1002 can be any type, size, or shape, and can be any material. For example, the bag-type pouch 1002 may be an individual box, an individual envelope, an individual container, an individual package, or an individual shrink-wrap.

The box 1001 has printed information on one or more of its surfaces 1003. A main label 1004 is attached to an exterior surface of the bag-type pouch 1002. The main label 1004 is generally a booklet-type label that includes two pages (or sheets), which are attached to each other along a single edge 1005. On the main label's cover 1006, which is the exterior surface of the top one of the two pages, the main label 1004 includes printed information (such as directions) related to the enclosed STP. It is contemplated that the main label may contain the same or similar information as the main label 18 of FIG. 2.

Referring to FIG. 11, the main label 1004 is shown in an opened position to reveal medical care product information 1111 printed inside the top (or cover) page 1108 and inside the bottom page 1109 of the main label 1004. The medical care product information 1111 can include STP instructions, directions, usage, ingredients, and/or warnings. According to this implementation, the main label 1004 can be opened by lifting a tab 1007. The medical care product information 1111 can be duplicative of information printed on the box 1001 and, optionally, can include additional information. According to an exemplary implementation, the information on the main label 1004 can include photographic instructions 1110, the same as or similar to the photographic instructions on the main label 18 described herein. The photographic instructions 1110 can be used in addition to or instead of the printed information as described herein in reference to the STP packages.

A removable label 1112 is optionally attached to the interior surface of the bottom page 1109 of the main label 1004 and can be used with the STPs in the same or similar manner as described in relation to the removable label 28 in FIG. 3. It is contemplated that the bag-type pouch 1002 may include a secondary label the same as or similar to secondary label 140 of FIG. 5.

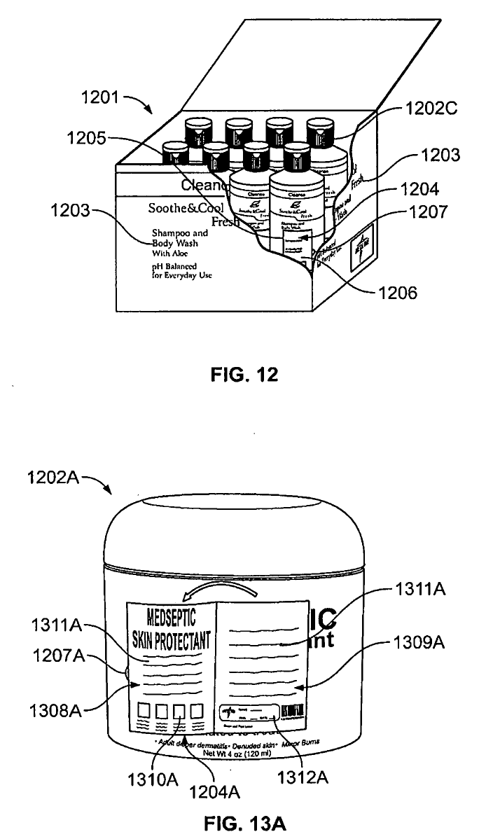

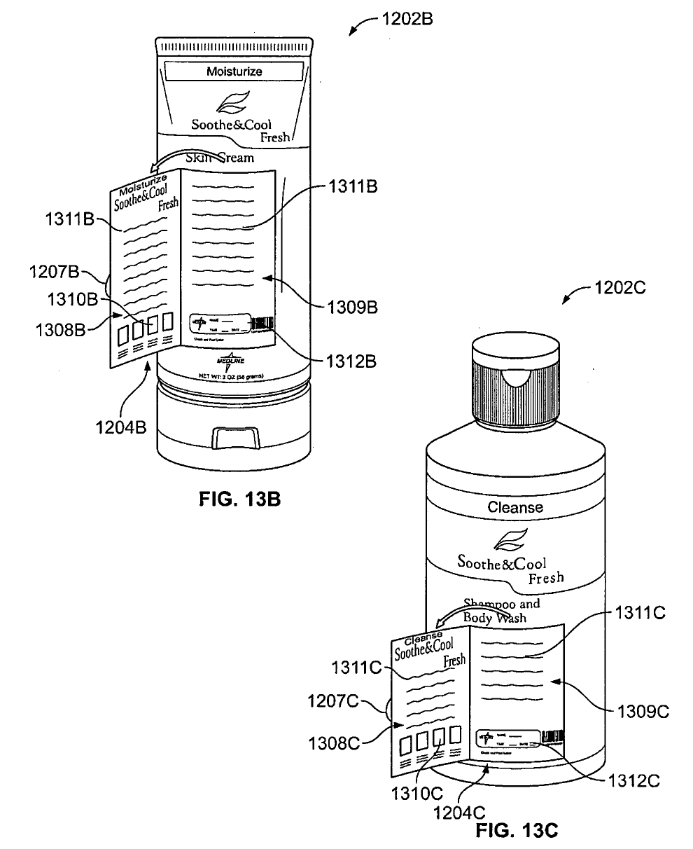

Referring to FIG. 12, a plurality of skin care products are packaged together in a single package. Examples of skin care products include lotions, cleansers, and protectants. The skin care product shown in FIG. 12 is a cleansing skin care product in a bottle-type package. The individual bottle-type packages shown in FIG. 12 can also be tube-type packages or jar-type packages containing any type of skin care product, such as those depicted in FIGS. 13A and 13B. According to one implementation, a package for the one or more skin care products includes a container in the shape of a box 1201 and a plurality of skin care products packaged individually in a bottle-type package 1202C (the skin care products can also be packaged individually in tube-type packages or jar-type packages, such as those shown in FIGS. 13B and 13A, respectively). In alternative implementations, the container can be any type, size, or shape, including, but not limited to, a circular box, a rectangular box, a bag, or a shrink-wrap; can be any material; and can include any number of skin care products. In other alternative implementations, the jar-type package 1202A, tube-type package 1202B, or the bottle-type package 1202C can be any type, size, or shape, and can be any material. For example, the jar-type package 1202A may be an individual box, an individual bag, an individual container, an individual envelope, or an individual pouch.

The box 1201 has printed information on one or more of its surfaces 1203. A main label 1204 is attached to an exterior surface of the bottle-type pouch 1202C. The main label 1204 is generally a booklet-type label that includes two pages (or sheets), which are attached to each other along a single edge 1205. On the main label's cover 1206, which is the exterior surface of the top one of the two pages, the main label 1204 includes printed information (such as directions) related to the enclosed skin care product. It is contemplated that the main label may contain the same or similar information as the main label 18 of FIGS. 2, 3.

Referring to FIGS. 13A-13C, the main labels 1204A-1204C are shown in opened positions to reveal medical care product information 1311A-1311C printed inside the top (or cover) pages 1308A-1308C and inside the bottom pages 1309A-1309C of the main labels 1204A-1204C. The medical care product information 1311A-1311C can include skin care product instructions, directions, usage, ingredients, and/or warnings. According to this implementation, the main labels 1204A-1204C can be opened by lifting tabs 1207A-1207C. The medical care product information 1311A-1311C can be duplicative of information printed on the box 1201 and, optionally, can include additional information. According to an exemplary implementation, the information on the main labels 1204A-1204C can include photographic instructions 1310A-1310C, the same as or similar to the photographic instructions on the main label 18 described herein. The photographic instructions 1310A-1310C can be used in addition to or instead of the printed information as described herein in reference to the skin care product packages.

Removable labels 1312A-1312C are optionally attached to the interior surface of the bottom pages 1309A-1309C of the main labels 1204A-1204C and can be used with the skin care products in a similar manner as described in relation to the removable label 28 in FIG. 3. It is contemplated that the jar-type, tube-type and bottle-type packages 1202A-1202C may include a secondary label the same as or similar to the secondary label 140 of FIG. 5.

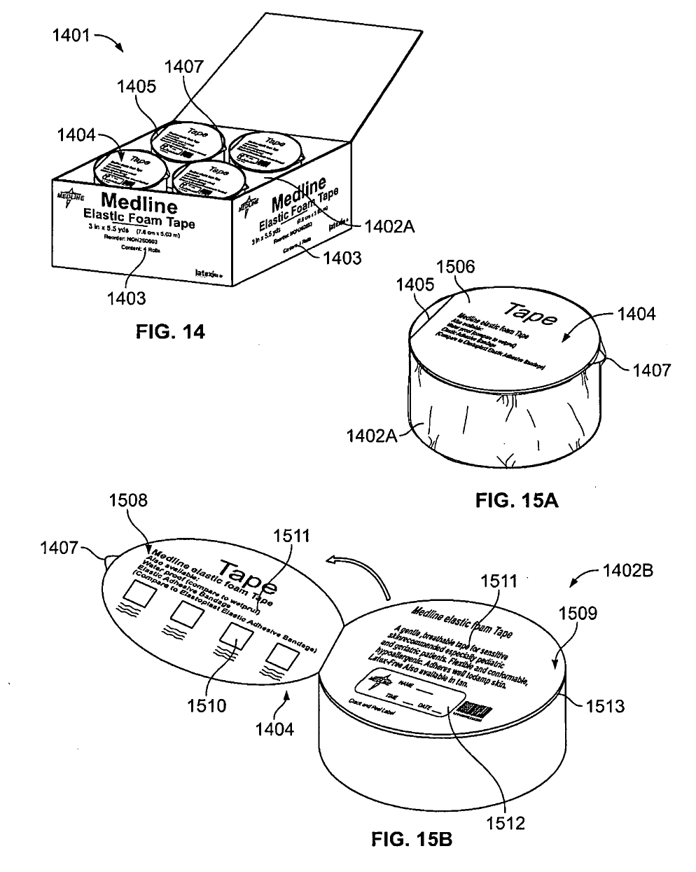

Referring to FIG. 14, a plurality of rolls of medical tape are packaged together in a single package. Medical tape typically comes in the form of a roll, where the medical tape is rolled around a core of material, wherein the core can be any material such as cardboard, plastic, or metal. The medical tape can be of any type, for example, paper, cloth, transparent, foam, or athletic. According to one implementation, a package for one or more rolls of medical tape includes a package housing in the shape of a box 1401 and a plurality of rolls of medical tapes packaged individually in a shrink-wrap pouch 1402A. In alternative implementations, the package housing can be any type, size, or shape, including, but not limited to, a circular box, a rectangular box, a bag, and a shrink-wrap; can be any material; and can include any number of rolls of medical tape. In other alternative implementations, the medical tape shrink-wrap pouch 1402A can be any type, size, or shape, and can be any material. For example, the shrink-wrap pouch 1402A may be an individual box, an individual envelope, an individual container or an individual bag (e.g., plastic bag or paper bag). In yet another alternative implementation, the rolls of medical tape can be packaged individually without a shrink-wrap pouch 1402B, as shown in FIG. 15B. In the embodiment where no individual shrink-wrap pouch 1402B is used, the main label 1404 is attached directly to the exterior surface 1513 of the roll of medical tape, as shown in FIG. 15B.

The box 1401 has printed information on one or more of its surfaces 1403. A main label 1404 is attached to an exterior surface of the shrink-wrap pouch 1402A. The main label 1404 is generally a booklet-type label that includes two pages (or sheets), which are attached to each other along a single edge 1405. On the main label's cover 1506, which is the exterior surface of the top one of the two pages, the main label 1404 includes printed information (such as directions) related to the enclosed roll of medical tape. It is contemplated that the main label 1404 may contain the same or similar information as the main label 18 of FIGS. 2, 3.

Referring to FIG. 15A, the main label 1404 is shown in a closed position attached to the exterior surface of the shrink-wrap pouch 1402A. Referring to FIG. 15B, the main label 1404 is shown in an opened position to reveal medical care product information 1511 printed inside the top (or cover) page 1508 and inside the bottom page 1509 of the main label 1404. The medical care product information 1511 can include tape instructions, directions, usage, ingredients, and/or warnings. According to this implementation, the main label 1404 can be opened by lifting a tab 1407. The medical care product information 1511 can be duplicative of information printed on the box 1401 and, optionally, can include additional information. According to an exemplary implementation, the information on the main label 1404 can include photographic instructions 1510, the same as or similar to the photographic instructions on the main label 18 described herein. The photographic instructions 1510 can be used in addition to or instead of the printed information as described herein in reference to the rolls of medical tape. In alternative implementations, the main label 1404 can be attached to the roll of medical tape on any surface, such as the side or bottom portions of the roll of medical tape.

A removable label 1512 is optionally attached to the interior surface of the bottom page 1509 of the main label 1404 and can be used with the rolls of medical tape in a similar manner as described in relation to the removable label 28 in FIG. 3. It is contemplated that the shrink-wrap pouch 1402A may include a secondary label the same as or similar to the secondary label 140 of FIG. 5.

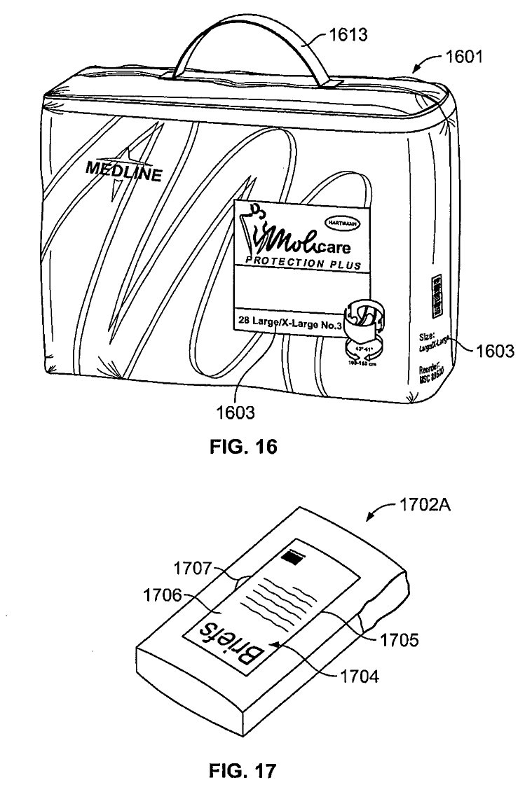

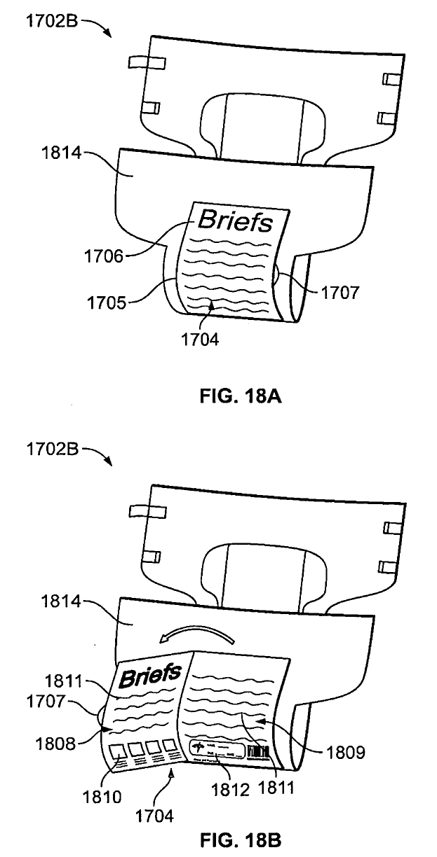

Referring to FIG. 16, a plurality of medical briefs (e.g. medical garments) are packaged together in a single package. The medical briefs can be of any material and of any type. For example, the medical briefs can be paper, cloth, plastic, or cotton; disposable, or reusable. According to one implementation, a package for one or more medical briefs includes a package housing in the shape of a box 1601 and a plurality of medical briefs packaged individually in a pouch 1702A, as shown in FIG. 17. In alternative implementations, the package housing can be any type, size, or shape, including, but not limited to, a circular box, a rectangular box, a plastic bag, and a shrink-wrap; can be any material; and can include any number of medical briefs. In other alternative implementations, the brief pouch 1702A can be any type, size, or shape, and can be any material. For example, the brief pouch 1702A may be an individual box, an individual envelope, an shrink-wrap, an individual container, or an individual bag (e.g., plastic or paper). In yet another alternative implementation, the medical briefs can be packaged individually without a pouch 1702B, as shown in FIGS. 18A-B. In the embodiment where no individual packaging is used, the main label 1704 is attached directly to the exterior surface of the medical brief 1814, as shown in FIGS. 18A-B.

The box 1601 may have a handle 1613 and printed information on one or more of its surfaces 1603. A main label 1704 is attached to an exterior surface of the pouch 1702A or to an exterior surface of the brief 1814. The main label 1704 is generally a booklet-type label that includes two pages (or sheets), which are attached to each other along a single edge 1705. On the main label's cover 1706, which is the exterior surface of the top one of the two pages, the main label 1704 includes printed information (such as directions) related to the enclosed medical brief. It is contemplated that the main label 1704 may contain the same or similar information as the main label 18 of FIGS. 2, 3.

Referring to FIG. 18A, the main label 1704 is shown in a closed position attached to the exterior surface of the medical brief 1814. Referring to FIG. 18B, the main label 1704 is shown in an opened position to reveal medical care product information 1811 printed inside the top (or cover) page 1808 and inside the bottom page 1809 of the main label 1704. The medical care product information 1811 can include medical brief instructions, directions, usage, ingredients, and/or warnings. According to this implementation, the main label 1704 can be opened by lifting a tab 1707. The medical care product information 1811 can be duplicative of information printed on the box 1601 and, optionally, can include additional information. According to an exemplary implementation, the information on the main label 1704 can include photographic instructions 1810, the same as or similar to the photographic instructions on the main label 18 described herein. The photographic instructions 1810 can be used in addition to or instead of the printed information as described herein in reference to the medical briefs.

A removable label 1812 is optionally attached to the interior surface of the bottom page 1809 of the main label 1704 and can be used with the medical briefs in a similar manner as described in relation to the removable label 28 in FIG. 3. It is contemplated that the pouch 1702A may include a secondary label the same as or similar to the secondary label 140 of FIG. 5.

While the present invention has been described with reference to one or more particular embodiments, those skilled in the art will recognize that many changes may be made thereto without departing from the spirit and scope of the present invention. For example, in certain alternative embodiments the main labels 18, 604, 804, 1004, 1204, 1404, and 1704, as shown in FIGS. 2, 6, 8, 10, 12, 14 and 17, can include multiple removable labels. The removable labels can be used to identify, for example, routine time periods during which the treating person has tended to the wound or other medical condition (e.g., a first removable label identifies that a routine wound check has been performed on the morning of day one, a second removable label identifies that a routine wound check has been performed on the evening of day two, etc.). According to other alternative implementations, the main labels can include more than two pages using an accordion-style format where each page is attached along one edge to one adjacent page and along an opposite edge to another adjacent page. According to other alternative implementations, it is contemplated that the tabs may be any size or shape and made from any material. Alternatively, it is contemplated that the main labels are provided without a tab. Any of the alternative embodiments can be used with any medical care product package described herein. Each of these embodiments and obvious variations thereof is contemplated as falling within the spirit and scope of the invention, which is set forth in the following claims.

What is claimed is:

1. A medical treatment package comprising:
at least one medical care product;
an individual container in which the at least one medical care product is stored prior to usage; and
a booklet-type label affixed to an exterior surface of the individual container, the booklet-type label including on its interior surface medical treatment information.

2. The medical treatment package of claim 1, further comprising at least one removable label attached to the booklet-type label.

3. The medical treatment package of claim 2, wherein the removable label includes a markable surface.

4. The medical treatment package of claim 2, wherein the removable label includes one or more of a crack-and-peel label and a perforated label.

5. The medical treatment package of claim 1, further comprising a secondary label having a set of directions for using the medical care product, the secondary label being located on the exterior surface of the individual container.

6. The medical treatment package of claim 1, wherein the individual container is one of a pouch, a plastic bag, a paper bag, an envelope, a box, a container or a shrink-wrap.

7. The medical treatment package of claim 1, wherein the at least one medical care product includes at least one of a woven gauze sponge, a sterile pad, an abdominal/combine pad, an impregnated gauze, a petroleum gauze, an oil emulsion gauze, a xeroform gauze, a gauze bandage roll, an elastic bandage roll, a cohesive wrap, an adhesive bandage, a sterile procedure tray, a cleansing skin care product, a lotion skincare product, a cream skin care product, a skin care product, a roll of medical tape, or a medical brief.

8. The medical treatment package of claim 1, further comprising a package housing containing a plurality of individual containers, one of the plurality of individual containers being the individual container in which the at least one medical care product is stored prior to usage, the package housing having usage information printed on at least one of its exterior surfaces.

9. A method for providing a medical treatment package, the method comprising:
inserting a medical care product into an individual container;
attaching a booklet-type label to an exterior surface of the individual container; and
providing a set of usage directions for treating a medical condition, the set of usage directions being located on an interior surface of the booklet-type label.

10. The method of claim 9, further comprising removably attaching at least one removable label to the booklet-type label.

11. The method of claim 10, further comprising providing a markable area on the removable label.

12. The method of claim 9, further comprising inserting a plurality of individual containers in a package housing, the plurality of individual containers including the individual container.

13. The method of claim 12, wherein the package housing includes usage information printed on at least one of its exterior surfaces.

14. The method of claim 9, further comprising attaching a sheet of directions in direct contact with an exterior surface of the individual container.

15. The method of claim 14, further comprising removably attaching the booklet-type label in direct contact with the sheet of directions.

16. A medical treatment package for treatment of a medical condition, the medical treatment package comprising:
a package housing;
a plurality of individually-contained medical care products stored in the package housing prior to usage; and
a booklet-type label affixed to an exterior surface of each of the plurality of individually-contained medical care products, the booklet-type label including on its interior surface medical treatment information for treatment of the medical condition.

17. The medical treatment package of claim 16, wherein the plurality of individually-contained medical care products includes at least one of a woven gauze sponge, a sterile pad, an abdominal/combine pad, an impregnated gauze, a petroleum gauze, an oil emulsion gauze, a xeroform gauze, a gauze bandage roll, an elastic bandage roll, a cohesive wrap, an adhesive bandage, a sterile procedure tray, a cleansing skin care product, a lotion skincare product, a cream skin care product, a skin care product, a roll of medical tape, or a medical brief.

18. The medical treatment package of claim 16, wherein the package housing has usage information printed on at least one of the exterior surfaces of the package housing.

19. The medical treatment package of claim 16, further comprising a secondary label having a set of directions for applying the plurality of individually contained medical care products, the secondary label being located on the exterior surfaces of the individual medical care products.

20. The medical treatment package of claim 16, wherein the plurality of individually-contained medical care products includes a combination of a woven gauze sponge, a sterile pad, an abdominal/combine pad, an impregnated gauze, a petroleum gauze, an oil emulsion gauze, a xeroform gauze, a gauze bandage roll, an elastic bandage roll, a cohesive wrap, an adhesive bandage, a sterile procedure tray, a cleansing skin care product, a lotion skincare product, a cream skin care product, a skin care product, a roll of medical tape, or a medical brief.
